(19) United States
(12) Patent Application Publication
(10) Pub. No.: US 2019/0301400 A1
(43) Pub. Date: Oct. 3, 2019

(54) ROCKETS EMBEDDED SCRAMJET NOZZLE (RESN)

(71) Applicant: Ajay P. KOTHARI, College Park, MD (US)

(72) Inventor: Ajay P. KOTHARI, College Park, MD (US)

(21) Appl. No.: 16/361,756

(22) Filed: Mar. 22, 2019

Related U.S. Application Data
(60) Provisional application No. 62/648,967, filed on Mar. 28, 2018.

(51) Int. Cl. F02K 7/18

(52) U.S. Cl. CPC F02K 7/18

(57) ABSTRACT

A combination of a plurality of rockets having an area ratio preferably in the range of 10 to 20, embedded in the interior of a nozzle of a scramjet with a modified aerospike exhaust nozzle provides a synergistic increase in total thrust greater than the sum of the thrusts of the rockets and the scramjet while increasing the speed and altitude range within which the scramjet is operable while reducing size and weight of the scramjet and avoiding a need for external rockets to reach operational speed for the scramjet, and to help with force when the Scramjet starts to starve for thrust production, and as a rocket for orbital insertion after scramjet cutoff with much higher expansion than conventional bell nozzle rockets such as the space shuttle main engine (SSME).

### CROSS-REFERENCE TO RELATED APPLICATIONS

This application claims benefit of priority of U.S. Provisional Application 62/648,967, filed Mar. 28, 2018, which is hereby incorporated by reference in its entirety.

### FIELD OF THE INVENTION

The present invention generally relates to vehicle propulsion systems comprised of scramjets and rockets and, more particularly, to combinations of rockets and scramjet nozzles allowing for a non-two dimensional, non-toroidal, non-plug cluster system, in combination with a three dimensional aerospike nozzle, fully termed Rockets Embedded in Scramjet Nozzle (RESN).

### BACKGROUND OF THE INVENTION

Hypersonic vehicles utilizing air breathing supersonic combustion ramjet (scramjet—a ramjet in which combustion occurs within a supersonic gas flow regime) engines traditionally require external devices to accelerate the vehicle in flow regimes where the scramjet engine may be inoperable. Scramjet engines require a very high-speed airflow at an inlet to compress a mixture of air and fuel to be ignited to provide a volume of gases at high pressure which expands against an exhaust nozzle and thus provide thrust. Accordingly, these flow regimes in which a scramjet is inoperable include flight in the upper atmosphere where air density and atmospheric pressure are very low, space (vacuum or near vacuum), and at lower freestream Mach numbers, and for take-off from ground. Presently in the current state-of-the-art, it has been suggested to use a combination of turbines and rockets to accelerate the scramjet from ground to Mach 3.5, at which point the ramjet flowpath can be ignited, providing thrust to the vehicle. More specifically, the speed that can be attained with turbine propulsion is limited to about Mach 2-2.5 and rocket propulsion is required to achieve a speed of about Mach 3.5 for efficient use of a ramjet. Vehicles using scramjets must also rely on rockets in the upper atmosphere, where the air density is too low for the scramjet.

It has been traditionally proposed to mount these rockets at an external location on the vehicle that is separate from the internal scramjet flowpath. However, such a configuration leads to increased vehicle weight and thus more fuel; also increasing weight. It follows that a larger scramjet would be needed to accommodate this extra mass.

These design problems are further complicated by the fact that traditional rockets utilizing substantially conical bell nozzles have limitations in their optimal operation. They are often designed for optimal performance at a specific altitude along the vehicle flight path. That is, bell nozzles have a length and expansion angle to provide an area ratio (AR) that will result in thrust within a suitable range for propulsion of a particular vehicle while the AR to provide optimum thrust will vary with ambient air pressure at the exhaust exit plane of the bell nozzle; lower pressures at higher altitudes requiring higher AR for efficient operation. Of course, rocket nozzles must be very robust structures that can develop thrust and transfer that thrust to the vehicle being propelled and thus, as a practical matter, cannot be altered in AR during operation. That is, any rocket nozzle will have a fixed length and fixed shape that is generally optimized in accordance with the rate of expansion of the combustion products of the burning fuel at a chosen ambient pressure. Therefore, the AR cannot be smoothly varied as altitude increases and ambient pressure diminishes. For example, two-stage rockets of a known type that is used to lift a payload into Earth orbit, referred to as two-stage to orbit (TSTO), the first stage will typically have bell nozzles with a small AR (e.g. less than 50) while the second stage that is used only in the low ambient pressure of the upper atmosphere will have a significantly larger AR (e.g. greater than 50 and typically greater than 100) and correspondingly greater length. Thus, the requirement for different rockets with different ARs for respective stages is a major reason for providing different rockets for multi-stage systems for placing satellites in orbit.

So-called aerospike nozzles, similar in overall shape and dimensions to comparable bell nozzles but having a sharply angled exhaust exit edges at different distances from the combustor where fuel is ignited, have addressed this issue by allowing for a reduced effective area ratio at higher pressure altitudes, and an increase in area ratio at lower pressure altitudes using the ambient pressure. In other words, aerospike nozzles provide a limited degree of ambient pressure compensation whereas none is provided by bell nozzles. Aerospike nozzles may be either a two-dimensional (2-D) or three-dimensional (3-D) configuration. The 2-D configuration has a curved surface (e.g. upper surface) at increasing distance (in the direction of flow from an opposing (e.g. lower) surface to develop thrust from exhaust gas expansion and, in a 2-D aerospike nozzle, the terminal edges of upper and lower surfaces being terminated at different distances from the combustor. The sides of the 2-D configuration are joined by further, generally parallel surfaces to confine the expanding gas. This 2-D configuration was proposed for the Venture Star (designated X-33) design but requires a compatible vehicle geometry. 2-D aerospike nozzles have highly rectangular combustor cross-section leading to high heat transfer and corresponding viscous drag resulting in lower performance.

The 3-D configuration is essentially non-rectangular with the terminal edge being either planar or scarfed (e.g. the shape being cut at non-planar locations). A toroidal aerospike nozzle requires a large number of separate nozzles and throats as they surround a circle and is thus unduly complex, structurally.

### SUMMARY OF THE INVENTION

It is therefore an object of the present invention to provide a solution to all of the above problems and design constraints by the simple expedient of embedding one or more lower expansion ratio rockets within a scramjet nozzle.

It is another object of the present invention to utilize the scramjet nozzle as it already exists within the vehicle for further expansion of rocket exhaust products to increase the effective AR of the rocket(s).

It is another object of the present invention to provide a propulsion system including a scramjet having a relatively small and light weight rocket system with a reduced AR that is capable of a thrust specific impulse greater than a space shuttle main engine and provide substantial gain in specific impulse thrust over a combination of a scramjet and rockets of similar design and type while also achieving a substantial reduction in size and weight.

It is a further object of the invention to provide for earlier and lower speed start of ramjets with higher temperature provided by rocket exhaust flow.

It is yet another object of the present invention to provide for operability of a scramjet over an increased range of altitude and ambient pressures.

It is yet another objective of the present invention to provide small size for the RESN rocket exit areas that would have minimal detrimental effect on ramjet or scramjet performance when only they are in operation during the purely air breathing phase.

In order to accomplish these and other objects of the invention, a propulsion system for a vehicle comprising, one or more rockets having an area ratio in a range of 3 to 50, and a scramjet including a nozzle having the one or more rockets embedded in an interior surface thereof and an aerospike exhaust outlet.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a partially transparent depiction of a vehicle including the invention.

FIG. 2 is a view of the interior of a scramjet nozzle including the invention.

FIG. 3 depicts a mesh illustrating surface of a scarfed RESN rocket.

FIG. 4 illustrates Mach contours of the scarfed RESN rocket of FIG. 3.

FIG. 5 illustrates the rotation effects of variation of truncation within the wall of a scramjet nozzle.

FIGS. 6 and 7 illustrate a mesh used for computation of flow Mach number, pressure, temperature and other flow variables using computational fluid dynamics (CFD) within the modified aerospike nozzle combined with embedded rockets in accordance with the invention.

FIGS. 8, 9 and 10 illustrate computed Mach number, pressure and temperature within the scramjet operating at a first set of vehicle speed and pressure/altitude conditions.

FIGS. 11, 12 and 13 illustrate computed Mach number, pressure and temperature within the scramjet operating at a second set of vehicle speed and pressure/altitude conditions.

FIGS. 14, 15 and 16 illustrate computed Mach number, pressure and temperature within the scramjet operating at a third set of vehicle speed and pressure/altitude conditions.

### DETAILED DESCRIPTION OF A PREFERRED EMBODIMENT OF THE INVENTION

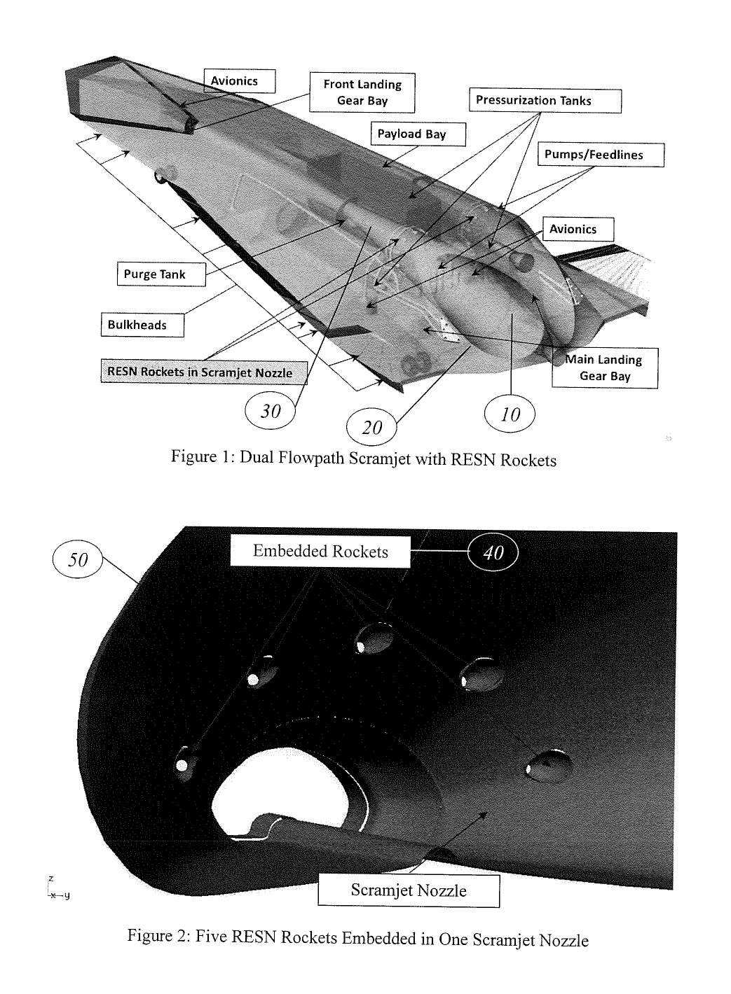

Referring now to the drawings, and more particularly to FIG. 1, there is shown, in partially transparent form to show placement of various system that would be required for horizontal take-off, horizontal landing (HTHL—although vertical take-off using a booster rocket is possible and may be preferred), hypersonic flight and orbital insertion. This design provides for an inward turning dual flowpath scramjet with embedded rockets in accordance with the invention although the invention can be practiced with only a single scramjet or more scramjets (e.g. four scramjets to form a full circular conic section of scramjets as might be desirable for a booster rocket to which a payload would be attached but would not be required to function as a maneuverable aircraft). The locations of the scramjet nozzle 10 with embedded rockets as shown in FIG. 2 and the modified aerospike exhaust nozzle 20 are shown. The location 30 of a combustor including a fuel injection and ignition torch for the scramjet is also shown. The air intake for the scramjet is generally located on the underside of the vehicle but in this particular design top side location is used for other considerations.

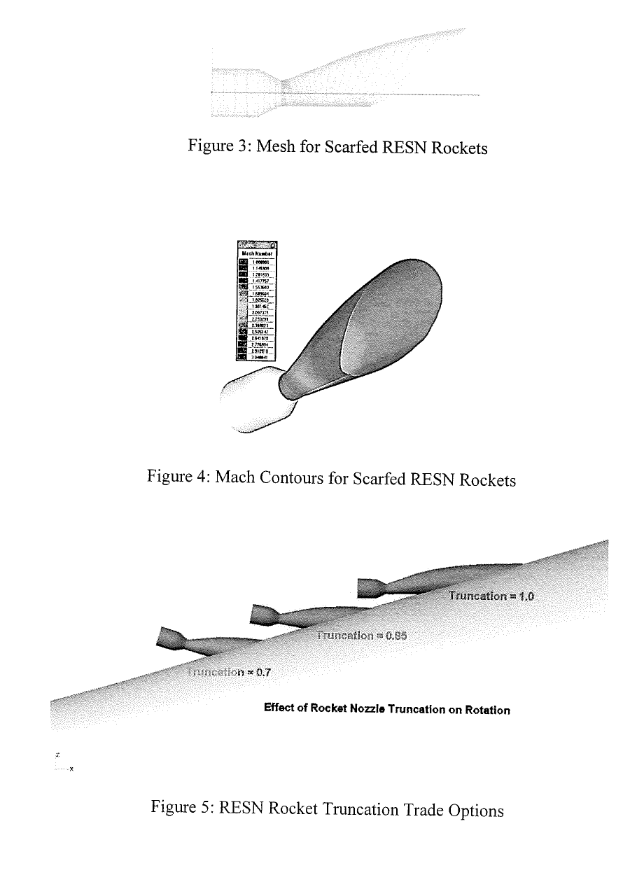

FIG. 2 illustrates an exemplary design for the embedding of a plurality of rocket nozzles on the interior of the scramjet nozzle. The rockets can be of any type that is currently available or foreseeable but a hydrogen and oxygen fueled rocket type is currently used for comparison with SSME (Space Shuttle Main Engine) performance. The rockets need not be on the same cross-sectional plane even though they are placed on the same characteristic plane in FIG. 1 as such placement is preferred for optimizing benefits of the invention while minimizing any detrimental effects to the scramjet flow path. It should be noted that the inlet of the scramjet nozzle is inward turning and preferably semi-circular as is conventional and that these rocket nozzles are also scarfed in accordance with the curved interior surface of the scramjet nozzle. FIG. 3 illustrates a mesh showing the surface of the interior of the rocket nozzles and FIG. 4 illustrates the increasing velocity within the rocket nozzles as the fuel burns and the gas within the rocket nozzles expands and increases in Mach number while confined by the nozzle.

The rocket nozzles may be of any arbitrary number but five is considered somewhat preferable in view of the increase in complexity for greater numbers of rockets. It is also preferred that the rocket nozzles 40 be located in a two-dimensional array (in axial view) preferably near the periphery of a portion of the scramjet nozzle or even surround the scramjet nozzle. As a perfecting feature of the invention, can be separately controlled to provide a degree of directed thrust either alone or in combination with the scramjet thrust to control yaw and pitch of the vehicle in which the invention is employed as control surfaces of the vehicle become progressively ineffective at very high altitudes, and also at other points in trajectory as they have relatively high thrust compared to the air breathing phase.

The scramjet nozzle 50 is carved out as a scarfed nozzle as shown in FIGS. 1 and 2. This is done using Method of Characteristic for the inviscid (i.e. non-viscous as in zero viscosity) and the Reference Temperature Method for the viscous contributions by using the proprietary code HySIDE (Hypersonic System Integrated Design Environment); both of which are standard computation methods/algorithms being conventional, accepted and well-understood in the aerospace community. This scarfing has the advantage that the ambient pressure has the ability to impose itself on the flow from the scarfed side of the nozzle in a manner that is similar to the 2D aerospike nozzle but unlike bell nozzles.

The invention, in its broadest expression is the provision of embedded rockets having a low (e.g. less than 50) AR appropriate to low altitude operation in the nozzle of a scramjet allowing for further rocket flow overall expansion of approximately 900 or higher effective AR which is the ratio of scramjet nozzle exit area to the total rocket throat area. Thus the potential for rocket flow expansion is very high, as is exploited by the present invention. This, in combination with a modified scarfed aerospike exhaust nozzle of limited AR and length as compared with known aerospike nozzles. The AR is computed using a projection of the terminal edge of the nozzle on a plane perpendicular to the nozzle axis divided by the throat area. As can be seen in FIG. 2, only a few RESN rocket throats are needed with the accompanying number of rocket nozzles only, just as in the case of a bell nozzle, and unlike the large number needed for toroidal aerospike engines, as alluded to above. Therefore, the invention is able to combine both the advantages of the bell and aerospike engines without the detrimental effect of either which were discussed above.

This placement of the rockets allows for aerospike characteristics within the scramjet nozzle. At higher altitudes where the pressure within the nozzle is much lower, the flow exiting the rocket can achieve much greater expansion ratios into the much greater volume of the scramjet exhaust nozzle; allowing for more optimal, increased thrust and resulting specific impulse. At lower altitudes, the ambient pressure is higher; leading to higher pressures within the scramjet nozzle. This automatically results in a decrease in expansion, relative to a lower pressure environment, allowing for more optimal rocket performance at lower altitudes. This effect is similar to the altitude compensation effect, alluded to above. However, the effect is much greater and differs from effects of traditional aerospike nozzles which is responsive only to the ambient pressure. In sharp contrast therewith, this invention exploits and is responsive to the pressure within the scramjet nozzle, itself, which is controllable through control of the embedded rockets and which, in most cases, is monotonically related to the ambient pressure and flight Mach number. That is, the rocket flow enters the scramjet nozzle at supersonic speed; continuing to expand and increase the vehicle thrust while also providing substantial gas flow within the scramjet even when the vehicle is stationary. Therefore, the rockets can provide substantial thrust even under conditions where the scramjet or ramjet cannot operate; presenting the possibility of horizontal take-off of a vehicle employing the invention from a standing start. Thereafter, as speed increases, the scramjet structure can be operated at subsonic (as in a ramjet) to supersonic speeds until the scramjet begins to operate with supersonic combustion. Scramjet operation can then be continued until atmospheric pressure falls to a point where the scramjet starves. It is important that, due to the flow from the rockets, scramjet operation can be continued to somewhat higher altitudes than is possible with the scramjet, alone. This expanded range of altitude and speed for scramjet operation is an important aspect of the unexpected and very substantial synergy of the combination of rockets embedded in the scramjet nozzle and the modified aerospike scramjet exhaust nozzle. These meritorious effects of the invention appear to be relatively consistent over the entire speed and altitude range for which scramjet operation is contemplated.

These benefits of the invention have been quantified by computational fluid dynamics (CFD) results which support the achievement of these meritorious effects as will now be described. Specifically, axisymmetric, two-dimensional results are computed to quantify performance benefits of this invention. The configurations and Figures presented here are for quantification purposes and do not embody the full scope of this invention.

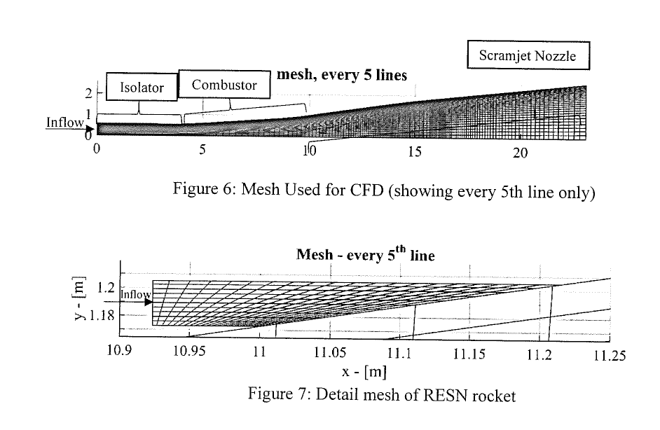

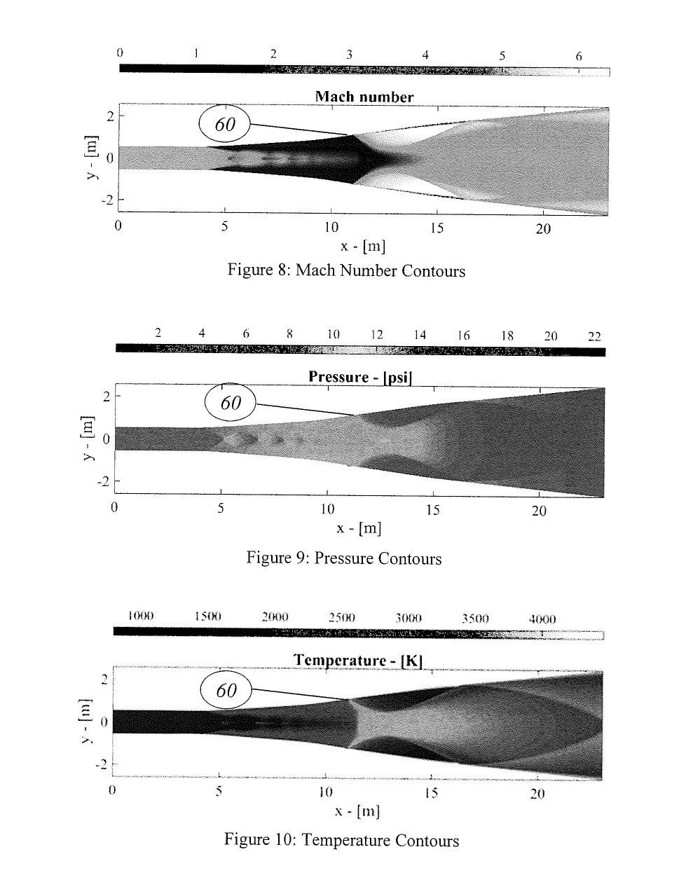

FIGS. 6 and 7 show the mesh used to simulate the flow within the scramjet nozzle of this invention. Here, every 5^{th} line is shown. FIG. 6 shows the 300×1000 mesh of the scramjet nozzle, combustor and isolator, while FIG. 7 shows the 50×100 mesh of the embedded rocket. The inflow of the embedded rocket is modeled as uniform flow produced by shaping its rocket nozzle with streamline tracing done in proprietary code HySIDE, with exit conditions of Mach 3.19, 40.63 psi, and 4420 degrees Rankine at pocket nozzle location 60 in FIGS. 8-10 and 14-16, corresponding to a hydrogen-oxygen rocket engine expanding to Area Ratio of 10. The mass flow simulated through this rocket is 220 kg/s. Computations are performed for each intersection in the meshes of FIGS. 6 and 7 to determine the Mach number, pressure and temperature of the flow and the results are integrated over the length of the isolator, combustor and the scramjet nozzle, as identified in FIG. 6 to determine the specific impulse, I_{SP}, performance of the invention. These computations are well-understood and conventional in the art.

To evaluate the performance benefits of this invention, the thrust is compared against a baseline thrust. This baseline thrust is the sum of two thrust values: 1. thrust from the scramjet nozzle with the same isolator inflow conditions and no embedded rocket, and 2. the thrust from the inflow conditions of the embedded rocket. The baseline thrust is then subtracted from the thrust of the simulation and then divided by the gravitational acceleration (for normalization) and rocket mass flow rate to obtain the I_{SP} (specific impulse), a traditional measure of rocket and scramjet performance.

FIGS. 8, 9, and 10 show the flowfield results at a scramjet isolator entrance condition of 0.5 psi, 1446 degrees Rankine, and Mach 3. This corresponds to a freestream flight condition of 164,000 ft., 0.012 psia pressure (80 Pascals) at Mach 6 with RESN rockets having an AR of 10. Here, the I_{SP} gain is 50.5 seconds with a total I_{SP} of 463 seconds.

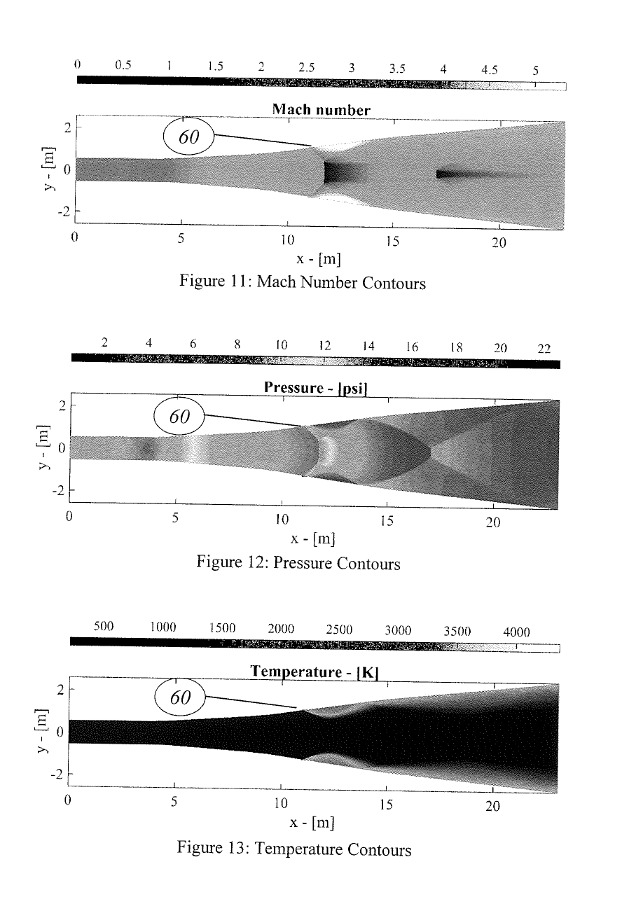

The results are similar for a different isolator entrance condition case, which corresponds to a lower altitude of 93,000 ft. and higher Mach number of 9.5 which would occur just before the scram cutoff at the start of orbital insertion phase. The CFD results are presented in FIGS. 11, 12, and 13. The isolator entrance condition here is 10.49 psi and Mach 4.71 with the same temperature as before. The embedded rocket conditions remain the same. The performance is again quantified with the same measure. In spite of the fact that at this trajectory point when freestream Mach number id 9.5 and the dynamic pressure is 2000 psf amounting to a substantial core flow, the I_{SP} gain is 27.9 seconds with a total rocket I_{SP} of 440 seconds. The external pressure compensation effect can clearly be seen in this example since substantial gain in I_{SP} over baseline performance is achieved even in extreme conditions almost at the limit of scramjet operability.

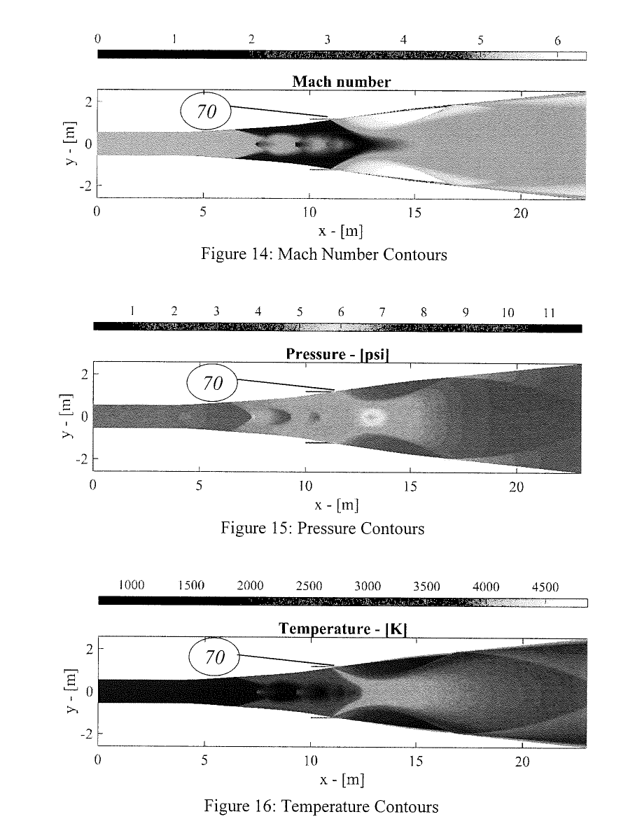

The same trend is seen for expanding the rocket flow further through the embedded rocket before expanding into the scramjet nozzle. In FIGS. 14, 15, and 16, the results are presented for the same isolator entrance conditions of FIGS. 8, 9, and 10. Here, the embedded rocket 70 is doubled in area, with rocket nozzle expanding to AR=20 (instead of 10 as used above), while maintaining the same stagnation conditions and mass flow rate. The rocket exit conditions are as follows: Mach 3.63, 16.55 psi, and 3845 degrees Rankine. Again, the gain in I_{SP} (measured same as before) is 35.4 seconds with a total I_{SP} of 465 seconds. Therefore, it appears that very consistent result can be achieved with rocket nozzles with any AR between 10 and 20 and is thus non-critical within this preferred AR range. From the general consistency of the results of these calculations for other examples, the invention is believed to produce some degree of I_{SP} gain for a range of AR from about 3 to about 50. The operational parameters and results for the above examples are summarized in the following Table

| | | Approximate Free Stream Condition | | | | Co-Flow at | |
|---|---|---|---|---|---|---|---|
| | | | Ambient | Ambient | | Isolator | |
| FIG. | | Altitude | Pressure | Pressure | | Pressure | |
| #s | Designation | K Ft | Pa | psi | Mach | psi | Mach |
| 8-10 | Low Q1 | 164 | 80 | 0.0116 | 6 | 0.5 | 3 |
| 11-13 | High Q1 | 93 | 1516 | 0.2199 | 9.5 | 10.49 | 4.71 |
| 14-16 | Low Q1 | 164 | 80 | 0.0116 | 6 | 0.5 | 3 |

| FIG. | RESN exit conditions | | | | Gain with RESN Concept | | |
|---|---|---|---|---|---|---|---|
| #s | Nozzle | Pressure | | ISP | Delta ISP | Total ISP | |
| (cont) | AreaRatio | psi | Mach | Sec | Sec | Sec | % of Ideal |
| 8-10 | 10 | 40.63 | 3.19 | 412.3 | 50.53 | 462.83 | 97.38% |
| 11-13 | 10 | 40.63 | 3.19 | 412.3 | 27.86 | 440.16 | 92.61% |
| 14-16 | 20 | 16.55 | 3.63 | 429.4 | 35.41 | 464.81 | 97.79% |

In view of the foregoing, it is clearly seen that the invention provides a solution to numerous problems and design constraints of scramjets having bell nozzles or conventional aerospike nozzles by the simple expedient of embedding one or more rockets within a scramjet nozzle. The invention also provides a propulsion system including a scramjet having a relatively small and light weight rocket system with a reduced AR (compared with known aerospike nozzles) that is capable of a specific impulse comparable to or greater than a space shuttle main engine and provides substantial gain in specific impulse over a combination of a scramjet and rockets of similar design and type while also achieving a substantial reduction in size and weight. The invention also provides for earlier and lower speed start of ramjets with higher temperature and reduced intake airflow speed environment provided by rocket exhaust flow as well as operability of a scramjet over an increased range of altitude and ambient pressure. With rockets having an AR in the range of 10-20, the total I_{SP} provided by the invention using comparable total rocket thrust is higher than the space shuttle main engine (SSME) and, within that range, performance appears to be independent of the AR of the rocket(s). That is, the invention provides a substantial gain in I_{SP} and thrust compared to a standalone rocket and scramjet of the same type. The altitude compensating aerospike characteristic provides near optimal thrust performance at an expanded range of altitudes.

The existence of the scramjet nozzle surface allows for high exhaust gas expansion of rockets embedded in the scramjet nozzle which may, themselves be of low expansion and area ratio such as near 10 to 20; outside of which range the meritorious effects of the invention other than thrust gain can be expected to be compromised. The total expansion of the rocket flow allows for substantial performance enhancement creatin specific impulse thrust much larger than if an external rocket such as the SSME were used, approximating about 462-465 seconds at high altitude beyond 150,000 feet. Further, in accordance with a preferred embodiment of the invention, the presence of RESN rocket exhaust does not adversely affect the I_{SP} performance of the scramjet more than 1-3 seconds which is approximately 0.0% of the scramjet I_{SP} at the same flight conditions.

While the invention has been described in terms of a single preferred embodiment, those skilled in the art will recognize that the invention can be practiced with modification within the spirit and scope of the appended claims.

Having thus described my invention, what I claim as new and desire to secure by Letters Patent is as follows:

1. A propulsion system for a vehicle, said propulsion system comprising, in combination,
one or more rockets having an area ratio in a range of 3 to 50, and
a scramjet, said scramjet including
a nozzle having said one or more rockets embedded in an interior surface thereof, and an aerospike exhaust outlet.

2. The propulsion system as recited in claim 1, wherein said one or more rockets are embedded in said nozzle in an array at a periphery of said nozzle of said scramjet.

3. The propulsion system as recited in claim 1, wherein the number of said rockets is five.

4. The propulsion system as recited in claim 1, wherein said modified aerospike nozzle has an elliptical exhaust opening.

5. The propulsion system as recited in claim 1, wherein an exhaust opening in said modified aerospike nozzle is scarfed.

6. The propulsion system as recited in claim 1 wherein said area ratio of said one or more rockets is in a range of 10 to 20.
